(19) United States
(12) Patent Application Publication
(10) Pub. No.: US 2021/0264033 A1
(43) Pub. Date: Aug. 26, 2021

(54) Dynamic Threat Actionability Determination and Control System

(71) Applicant: Bank of America Corporation, Charlotte, NC (US)

(72) Inventors: Mary Adelina Quigley, Indian Trail, NC (US); Kimberly Jane Nowell-Berry, Palm City, FL (US)

(21) Appl. No.: 16/795,981

(22) Filed: Feb. 20, 2020

(51) Int. Cl. G06F 21/57; G06N 5/02; G06N 20/00; G06Q 10/06

(52) U.S. Cl. CPC G06F 21/577; G06N 5/02; G06F 2221/034; G06Q 10/0635; G06N 20/00

(57) ABSTRACT

Arrangements for dynamically determining actionability of incidents of compromise are provided. In some examples, a plurality of threat intelligence data feeds may be received. The feeds may be analyzed to identify one or more incidents of compromise. In some examples, each incident of compromise may be further evaluated to identify an intelligence type associated with the incident of compromise. Based on the intelligence type, system logs may be evaluated to determine whether they include an occurrence of the incident of compromise. If so, the incident of compromise may be identified as actionable. If not, the incident of compromise may be identified as inactionable. In some examples, additional information associated with actionable incidents of compromise may be retrieved and evaluated to prioritize further processing of the actionable incident of compromise. The actionable incident of compromise, as well as other information, may then be further processed to identify and execute mitigating actions, and the like.

### BACKGROUND

Aspects of the disclosure relate to electrical computers, systems, and devices for threat actionability determination and control. In particular, one or more aspects of the disclosure relate to evaluating identifying incidents of compromise and dynamically determination the actionability of those incidents of compromise.

Business entities are diligent about quickly and efficiently identifying potential instances of a security compromise. Many large enterprise organizations subscribe to threat intelligence data feeds that provide data including indications of potential security compromises.

In many organizations, a significant number of data feeds are received and it may be difficult to identify feeds providing accurate and timely information. Further, once timely and accurate information is identified, it is difficult to determine whether the threat is actionable for the enterprise. Accordingly, it would be advantageous to evaluate threat intelligence data feeds to identify threats or potential threats and dynamically determine actionability of the threats or potential threats.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with dynamically determining actionability of detected credible threats to security of an entity.

In some examples, a plurality of threat intelligence data feeds may be received. For instance, threat intelligence data feeds may be received from a plurality of sources associated with a plurality of providers or entities. The threat intelligence data feeds may be analyzed to identify one or more incidents of compromise. In some examples, each incident of compromise may be further evaluated to identify an intelligence type associated with the incident of compromise. Based on the intelligence type, system logs may be retrieved and evaluated to determine whether they include an occurrence of the incident of compromise being evaluated. If so, the incident of compromise may be identified as actionable. If not, the incident of compromise may be identified as inactionable.

In some examples, additional information associated with actionable incidents of compromise may be retrieved and evaluated (e.g., using machine learning) to prioritize further processing of the actionable incident of compromise. The actionable incident of compromise, as well as the priority, additional information, and the like, may then be further processed to identify and execute mitigating actions, and the like.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing dynamic threat actionability determination and control functions in accordance with one or more aspects described herein;

FIGS. 2A-2G depict an illustrative event sequence for implementing dynamic threat actionability determination and control functions in accordance with one or more aspects described herein;

FIG. 3 depicts an illustrative method for implementing and using dynamic threat actionability determination and control functions according to one or more aspects described herein;

FIG. 4 illustrates an example user interfaces that may be generated and displayed in accordance with one or more aspects described herein;

FIG. 5 illustrates one example operating environment in which various aspects of the disclosure may be implemented in accordance with one or more aspects described herein; and

FIG. 6 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to threat intelligence data evaluation, dynamic actionability determination, and the like.

As mentioned above, large enterprise organizations often receive threat intelligence data from a variety of sources. However, the number of sources may make it difficult to efficiently identify threat data that is accurate, timely, actionable, or the like.

Accordingly, arrangements discussed herein may provide for dynamic determination of actionable indicators of compromise received from one or more threat intelligence data feeds.

For instance, large enterprise organizations may receive threat intelligence data from a plurality of sources that may include hundreds of thousands of indicators of compromise (e.g., data that may identify potentially malicious activity on a system or network). Efficiently determining which indicators of compromise are actionable is important to protecting entity resources.

As discussed herein, data from threat intelligence data feeds may be analyzed and one or more indicators of compromise may be identified. As will be discussed more fully herein, an intelligence type of each indicator of compromise may be determined and one or more system logs for evaluation may be retrieved. The system logs may be evaluated to identify an occurrence of an indicator of compromise in the logs. If so, the indicator of compromise may be deemed actionable. If not, the indicator of compromise may be deemed inactionable.

In some examples, actionable indicators of compromise may be prioritized for further processing based on additional information associated with the indicator of compromise. The actionable indicators of compromise may then be further processed to determine accuracy of data received, identify and execute mitigating actions, and the like.

These and various other arrangements will be discussed more fully below.

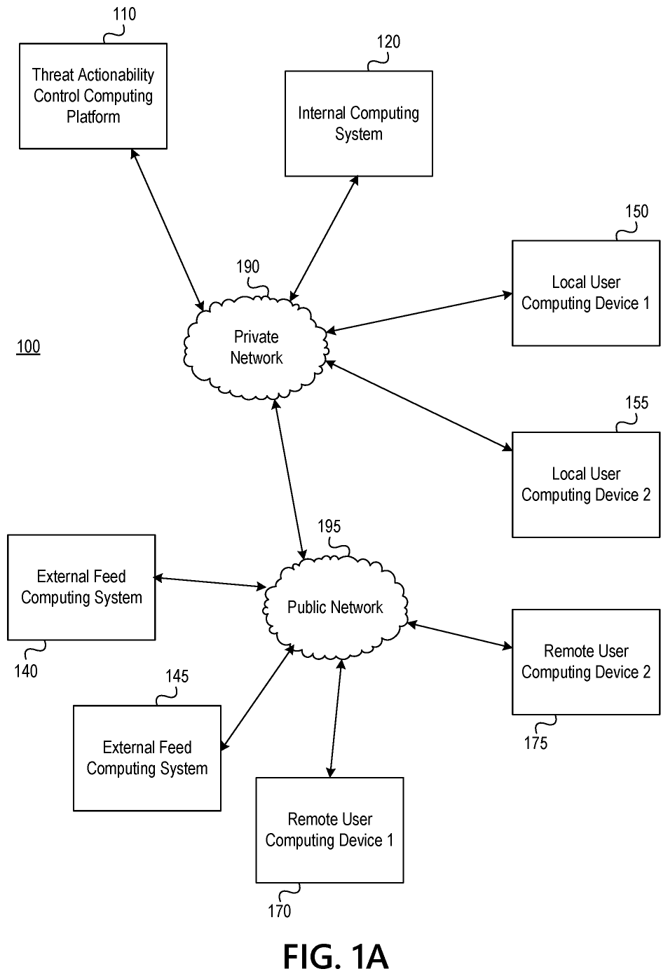

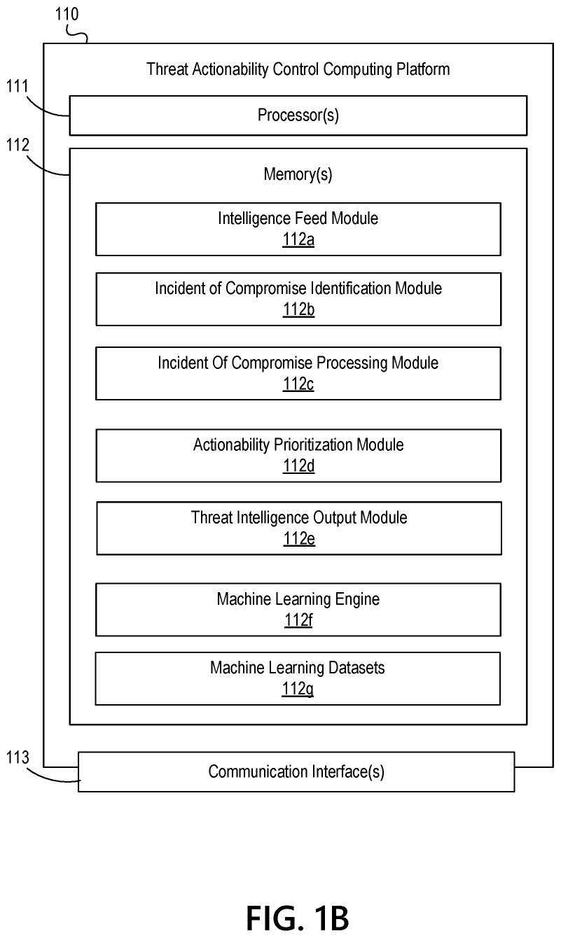

FIGS. 1A and 1B depict an illustrative computing environment for implementing and using a system for dynamic threat actionability control functions in accordance with one or more aspects described herein. Referring to FIG. 1A, computing environment 100 may include one or more computing devices and/or other computing systems. For example, computing environment 100 may include threat actionability control computing platform 110, internal computing system 120, external feed computing system 140, external feed computing system 145, a first local user computing device 150, a second local user computing device 155, a first remote user computing device 170, and a second remote user computing device 175. Although only one internal computing system is shown, more systems or devices may be used without departing from the invention. Further, although two external feed computing systems, two local user computing devices and two remote user computing devices are shown, more or fewer may be used without departing from the invention.

Threat actionability control computing platform 110 may be configured to provide intelligent, dynamic threat actionability analysis and control that may be used to evaluate threat intelligence feeds and data, evaluated identified indicators of compromise (e.g., identified threats within the intelligence feeds), update and validate machine learning datasets and/or models used to detect potential threats, and the like. For instance, threat actionability data may be received from a plurality of sources, such as external feed computing system 140, external feed computing system 145, and the like. In some examples, the threat intelligence feed data may be analyzed using one or more models, machine learning, and the like, to detect potential threats within the data (e.g., indicators of compromise), determine accuracy of threats, evaluate reliability of sources, and the like. The analyzed data may then be further evaluated to determine actionability of identified indicators of compromised.

For instance, threat actionability control computing platform 110 may identify one or more indicators of compromise within the analyzed data (e.g., indicators of compromise from reliable sources, having a credible threat, related to a previous threat or issue, or the like). In some examples, an intelligence type associated with the identified one or more indicators of compromise may be determined. Based on the determined intelligence type, one or more system logs associated with one or more systems within an entity implementing the threat actionability control computing platform 110 may be identified. In some examples, the identified system logs may be further analyzed to determine whether the identified indicator of compromise is present within the identified logs. Based on the determination, the evaluated indicator of compromise may be deemed actionable or inactionable. For instance, the determination may result in a binary output such that, if an identified indicator of compromise is found in the analyzed logs, the indicator of compromise may be deemed actionable and, if not, may be deemed inactionable.

In some examples, the binary output may be used to update and/or validate one or more machine learning datasets (e.g., used in an initial evaluation of threat intelligence data, in determining actionability, or the like).

In some arrangements, after a determination that an indicator of compromise is actionable, additional information associated with the indicator of compromise may be retrieved. For instance, a source of the indicator of compromise, steps taken to mitigate impact associated with the indicator of compromise, and the like, may be retrieved and analyzed (e.g., using machine learning) to prioritize further processing of the indicator of compromise. Based on the binary output and the priority, the indicator of compromise may be further processed to evaluate a threat associated with the indicator of compromise, identify and/or execute one or more mitigating actions, and the like. The output of the further process may also be used to update and/or validate one or more machine learning datatsets and/or models used to evaluate threat intelligence data.

Computing environment 100 may further include an internal computing system 120. In some examples, internal data computing system 120 may receive, transmit, process and/or store data internal to the entity implementing the threat actionability control computing platform 110. For instance, internal computing system 120 may host and/or execute one or more applications used by the entity, store data associated with internal processes, and the like.

Computing environment 100 may further include one or more external feed computing systems, such as external feed computing system 140, external feed computing system 145, and the like. As mentioned above, although two external feed computing systems are shown, more or fewer external feed computing systems may be used without departing from the invention. In some examples, data may be received from a plurality of external feed computing systems (e.g., tens or hundreds or feeds received).

External feed computing systems 140, 145 may be associated with an entity separate from the entity implementing the threat actionability control computing platform 110. In some examples, external feed computing systems 140, 145 may provide threat intelligence feeds to the entity implementing the threat actionability control computing platform 110. For instance, data feeds including threat intelligence data may be transmitted, via the external feed computing systems 140, 145 to the threat actionability control computing platform 110 for analysis, mitigation actions, and the like. In some examples, the threat intelligence data may be processed, e.g., to identify reliable sources, determine credible threats, and the like, by the threat actionability control computing platform 110 and/or other systems or devices prior to evaluating the data for actionable threats.

Local user computing device 150, 155 and remote user computing device 170, 175 may be configured to communicate with and/or connect to one or more computing devices or systems shown in FIG. 1A. For instance, local user computing device 150, 155 may communicate with one or more computing systems or devices via network 190, while remote user computing device 170, 175 may communicate with one or more computing systems or devices via network 195. In some examples, local user computing device 150, 155 may be used to access one or more entity systems, functions or processes. In some examples, local user computing device 150, 155 may be used to modify intelligence data feed evaluation parameters, display outputs such as actionability, display items for further processing or evaluation (e.g., by an analyst), receive user input from an analyst that may be used to update or validate one or more machine learning datasets, or the like.

The remote user computing devices 170, 175 may be used to communicate with, for example, threat actionability control computing platform 110. For instance, remote user computing devices 170, 175 may include user computing devices, such as mobile devices including smartphones, tablets, laptop computers, and the like, that may be used to communicate with threat actionability control computing platform 110, implement mitigation actions, and the like.

In one or more arrangements, internal data computing device 120, external feed computing system 140, external feed computing system 145, local user computing device 150, local user computing device 155, remote user computing device 170, and/or remote user computing device 175 may be any type of computing device or combination of devices configured to perform the particular functions described herein. For example, internal data computing system 120, external feed computing system 140, external feed computing system 145, local user computing device 150, local user computing device 155, remote user computing device 170, and/or remote user computing device 175 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of internal data computing system 120, external feed computing system 140, external feed computing system 145, local user computing device 150, local user computing device 155, remote user computing device 170, and/or remote user computing device 175 may, in some instances, be special-purpose computing devices configured to perform specific functions.

Computing environment 100 also may include one or more computing platforms. For example, and as noted above, computing environment 100 may include threat actionability control computing platform 110. As illustrated in greater detail below, threat actionability control computing platform 110 may include one or more computing devices configured to perform one or more of the functions described herein. For example, threat actionability control computing platform 110 may include one or more computers (e.g., laptop computers, desktop computers, servers, server blades, or the like).

As mentioned above, computing environment 100 also may include one or more networks, which may interconnect one or more of threat actionability control computing platform 110, internal data computing system 120, external feed computing system 140, external feed computing system 145, local user computing device 150, local user computing device 155, remote user computing device 170, and/or remote user computing device 175. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, threat actionability control computing platform 110, internal data computing system 120, local user computing device 150, local user computing device 155, and, may be associated with an organization (e.g., a financial institution), and private network 190 may be associated with and/or operated by the organization, and may include one or more networks (e.g., LANs, WANs, virtual private networks (VPNs), or the like) that interconnect threat actionability control computing platform 110, internal data computing system 120, local user computing device 150, local user computing device 155, and one or more other computing devices and/or computer systems that are used by, operated by, and/or otherwise associated with the organization. Public network 195 may connect private network 190 and/or one or more computing devices connected thereto (e.g., threat actionability control computing platform 110, internal data computing system 120, local user computing device 150, local user computing device 155) with one or more networks and/or computing devices that are not associated with the organization. For example, external feed computing system 140, external feed computing system 145, remote user computing device 170, remote user computing device 175, might not be associated with an organization that operates private network 190 (e.g., because external feed computing system 140, external feed computing system 145, remote user computing device 170, remote user computing device 175, may be owned, operated, and/or serviced by one or more entities different from the organization that operates private network 190, such as a second entity different from the entity, one or more customers of the organization, public or government entities, and/or vendors of the organization, rather than being owned and/or operated by the organization itself or an employee or affiliate of the organization), and public network 195 may include one or more networks (e.g., the internet) that connect external feed computing system 140, external feed computing system 145, remote user computing device 170, remote user computing device 175, to private network 190 and/or one or more computing devices connected thereto (e.g., threat actionability control computing platform 110, internal data computing system 120, local user computing device 150, local user computing device 155).

Referring to FIG. 1B, threat actionability control computing platform 110 may include one or more processors 111, memory 112, and communication interface 113. A data bus may interconnect processor(s) 111, memory 112, and communication interface 113. Communication interface 113 may be a network interface configured to support communication between threat actionability control computing platform 110 and one or more networks (e.g., private network 190, public network 195, or the like). Memory 112 may include one or more program modules having instructions that when executed by processor(s) 111 cause threat actionability control computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of threat actionability control computing platform 110 and/or by different computing devices that may form and/or otherwise make up threat actionability control computing platform 110.

For example, memory 112 may have, store and/or include an intelligence feed module 112a. Intelligence feed module 112a may store instructions and/or data that may cause or enable the threat actionability control computing platform 110 to receive threat intelligence data feeds from one or more sources (e.g., external feed computing system 140, external feed computing system 145, or the like). In some examples, the data feeds may be received by the intelligence feed module 112a and may be formatted, as needed, for further processing. In some arrangements, intelligence feed module 112a may cause data from one or more threat intelligence feeds to be stored, such as in a database. In some arrangements, intelligence feed module may execute one or more processes to perform an initial evaluation of the data within each intelligence feed to identify credible threats, determine a confidence score associated with a credible threat, and the like.

Threat actionability control computing platform 110 may further have, store and/or include indicator of compromise identification module 112b. Indicator of compromise identification module 112b may store instructions and/or data that may cause or enable the threat actionability control computing platform 110 to analyze threat intelligence feed data (e.g., raw feed data, data previously processed by, for instance, the intelligence feed module 112a to identify potential incidents, or the like) to identify one or more incidents of compromise in the data or identified as a potential threat. Each identified indicator of compromise may then be further processed to evaluate an actionability of the indicator of compromise.

Threat actionability control computing platform 110 may further have, store and/or include indicator of compromise processing module 112c. Indicator of compromise processing module 112c may store instructions and/or data that may cause or enable the threat actionability control computing platform 110 to further process identified incidents of compromise. For example, an intelligence type associated with each indicator of compromise identified (e.g., by indicator of compromise identification module 112b) may be determined. Some example intelligence types may include internet protocol (IP) addresses, domains, file hashes, universal resource locators (URL), email addresses, and the like. In some examples, intelligence types may include subsets of categories. For instance, intelligence types may include IP addresses, as well as malware IP addresses, APT IP addresses, and the like.

In some arrangements, logic may be executed to identify the intelligence type associated with the indicator of compromise. After an intelligence type is determine for a particular indicator of compromise, the intelligence type may be mapped to one or more system logs associated with various systems, devices, applications, and the like, executed or in use by an entity implementing the threat actionability control computing platform 110. Accordingly, one or more system logs for evaluation may be identified and retrieved based on the intelligence type. In some arrangements, the intelligence types may be narrowly focused (e.g., specific types of IP addresses, file hashes, or the like) to aid in accurately identifying appropriate system logs for evaluation, reviewing only desired system logs without unnecessary evaluation of system logs not likely to include the indicator of compromise which may decrease efficiency, and the like.

Indicator of compromise processing module 112c may further analyze the identified system logs to determine whether the indicator of compromise being evaluated is present in the system logs. If so, the indicator of compromise may be identified as actionable. If not, the indicator of compromise may be identified as inactionable. In some arrangements, actionable incidents of compromise may be further processed.

For instance, actionability prioritization module 112d may store instructions and/or data that may cause or enable the threat actionability control computing platform 110 to retrieve additional information related to the indicator of compromise identified as actionable in order to prioritize further processing of the indicator of compromise. For instance, information related to a source data feed from which the indicator of compromise was identified may be retrieved. A reliability or confidence factor associated with the source may be retrieved or identified and may be used to prioritize the actionable indicator of compromise. In another example, mitigation efforts and outcome associated with a previous occurrence of the indicator of compromise may be retrieved and used to prioritize the actionable indicator of compromise. Various other data and/or factors may be used to prioritize the actionable indicator of compromise without departing from the invention.

Threat actionability control computing platform 110 may further have, store and/or include threat intelligence output module 112e. In some examples, threat intelligence output module 112e may store instructions and/or data that may cause or enable the threat actionability control computing platform 110 to generate an output, such as a user interface, including identification of an actionable indicator of compromise, a determined priority, and the like. In some arrangements, the threat intelligence output module 112e may transmit the generated output to another computing device, such as local user computing device 150, local user computing device 155, or the like, for further processing. In some examples, further processing may include further analysis of the actionable indicator of compromise, identification of mitigating actions, execution of one or more mitigating actions, and the like. In some arrangements, user input from one or more threat intelligence analysts may be received (e.g., by local user computing device 150, local user computing device 155, or the like) and transmitted to the threat actionability control computing platform 110 to update and/or validate one or more threat assessment models, machine learning datasets, and the like. In some examples, the user input may include an output of further analysis by the analyst, mitigating actions taken, impact after mitigating actions were executed, and the like.

Various aspects associated with the threat actionability control computing platform 110 may be performed using machine learning. Accordingly, threat actionability control computing platform 110 may have, store and/or include a machine learning engine 112f and machine learning datasets 112g. Machine learning engine 112f and machine learning datasets 112g may store instructions and/or data that may cause or enable threat actionability control computing platform 110 to analyze data to identify patterns or sequences within threat data or indicator of compromise data, identify a priority for further processing, identify mitigating actions to execute, and the like. The machine learning datasets 112g may be generated based on analyzed data (e.g., data from previously received data, and the like), raw data, and/or received from one or more outside sources.

The machine learning engine 112f may receive data and, using one or more machine learning algorithms, may generate one or more machine learning datasets 112g. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. Additional or alternative machine learning algorithms may be used without departing from the invention.

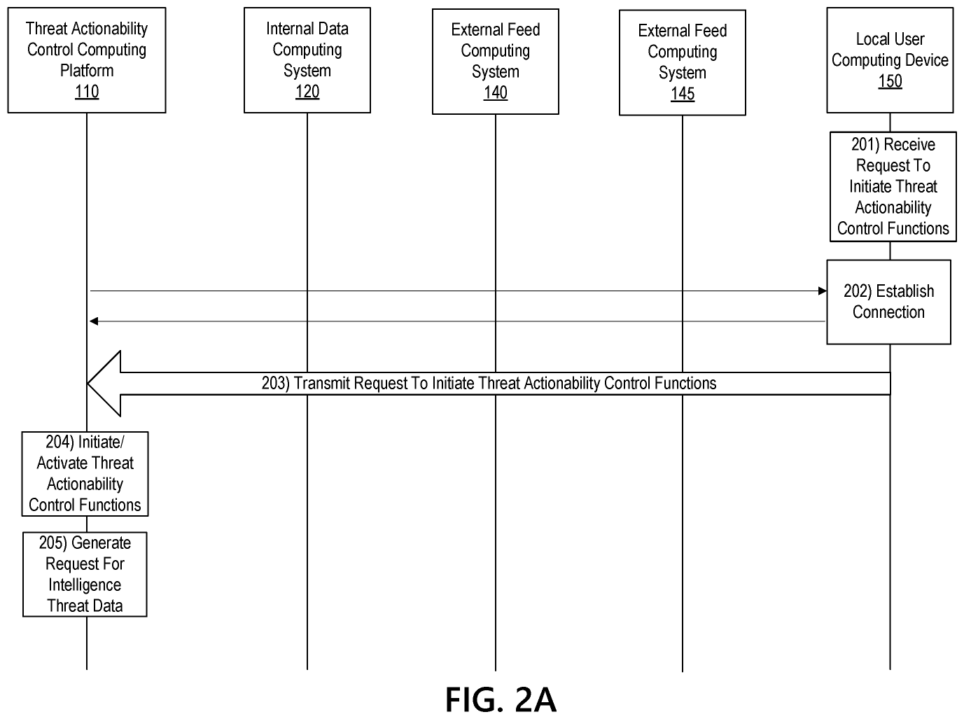

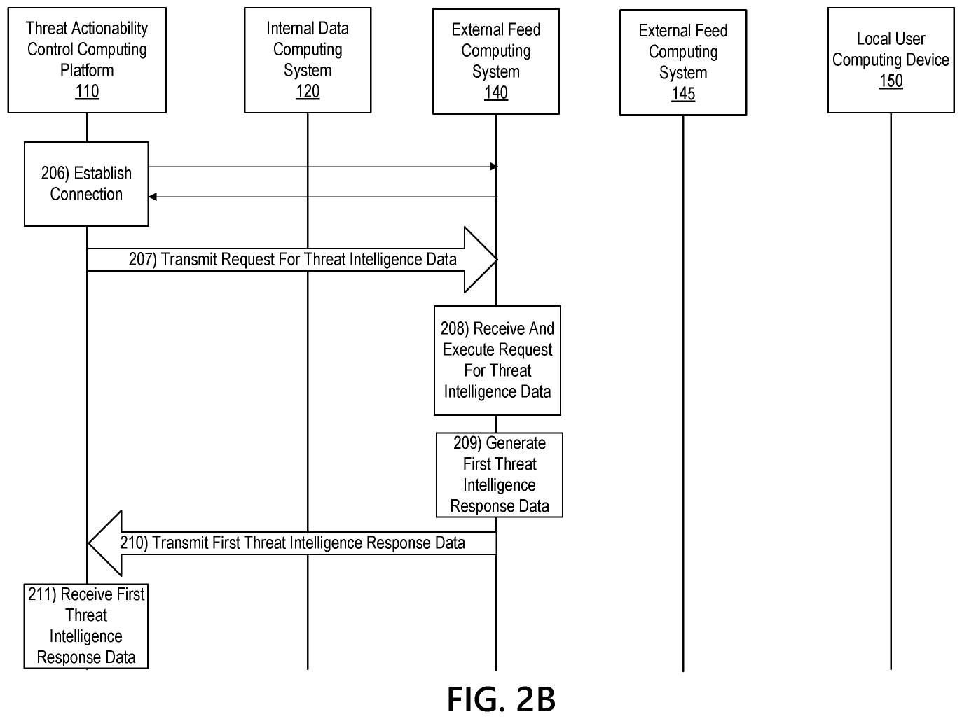

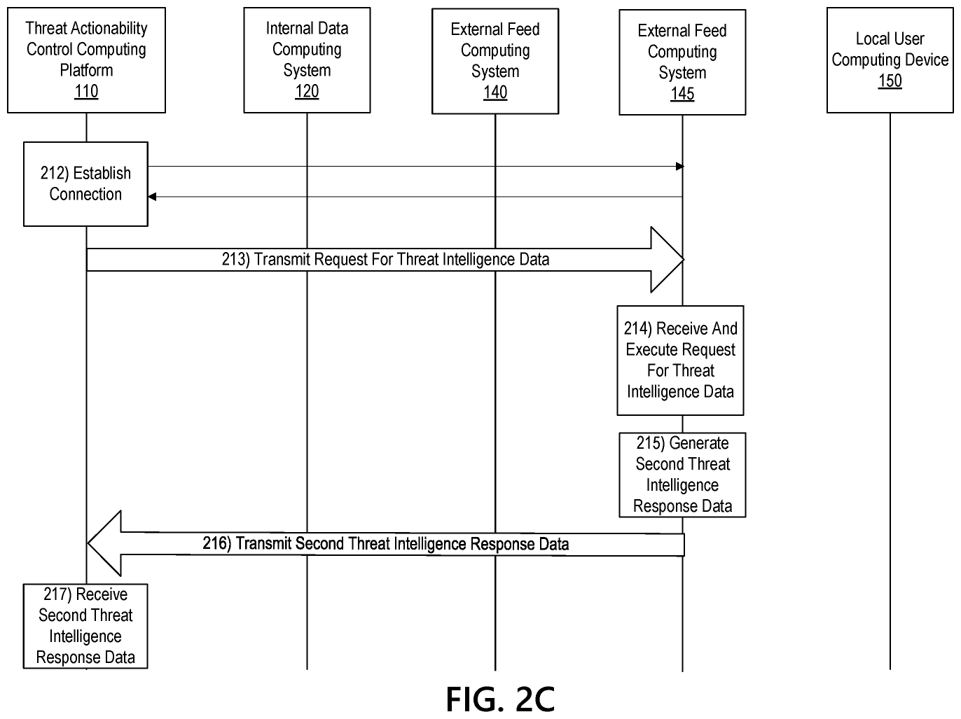

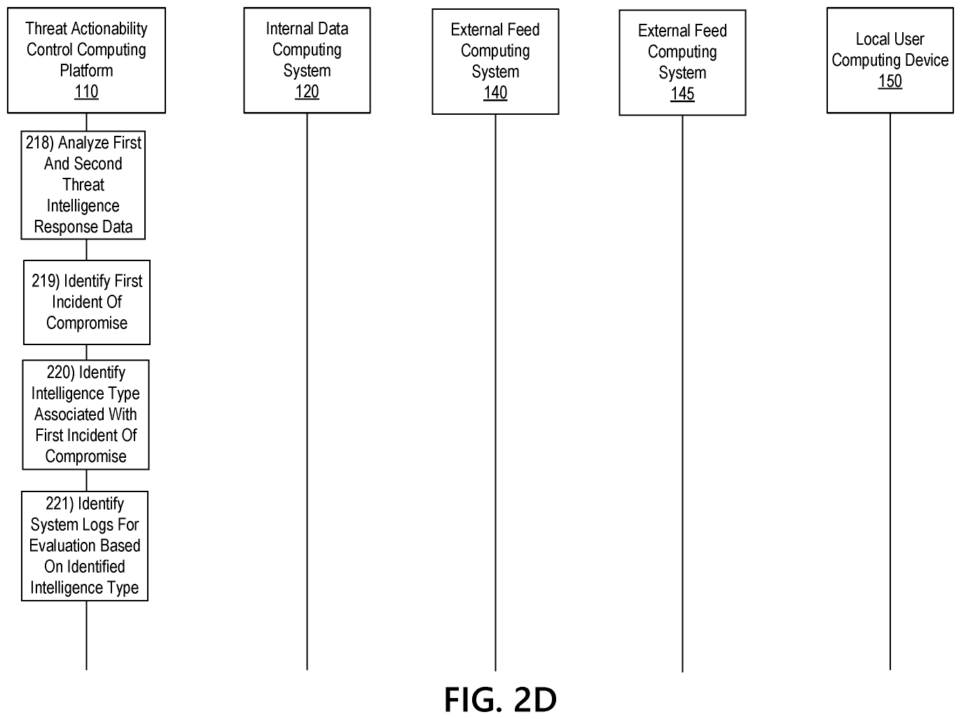

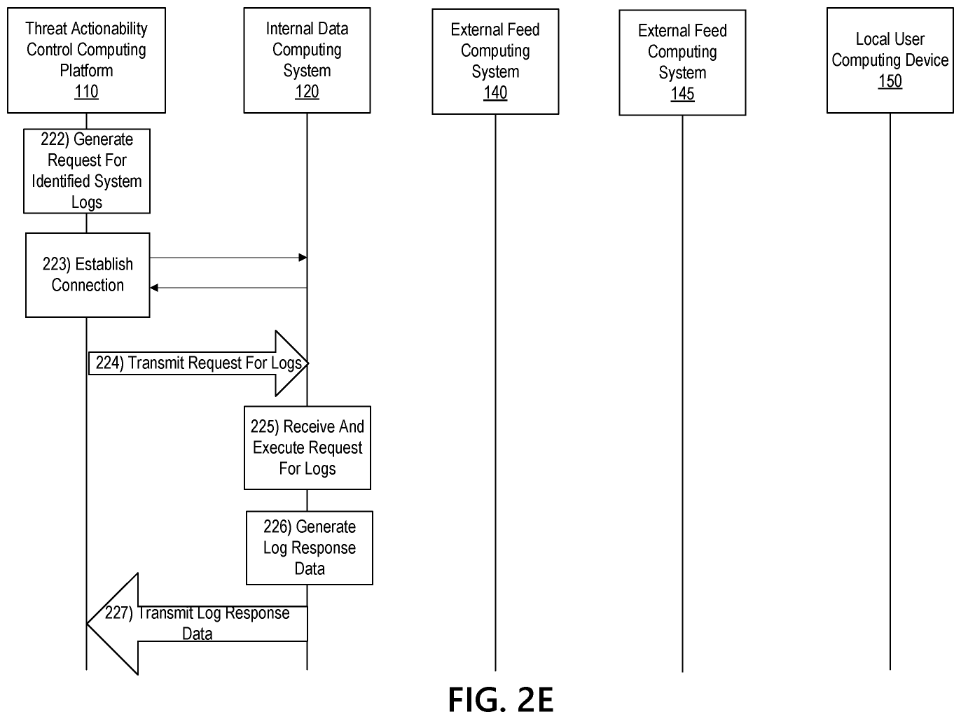

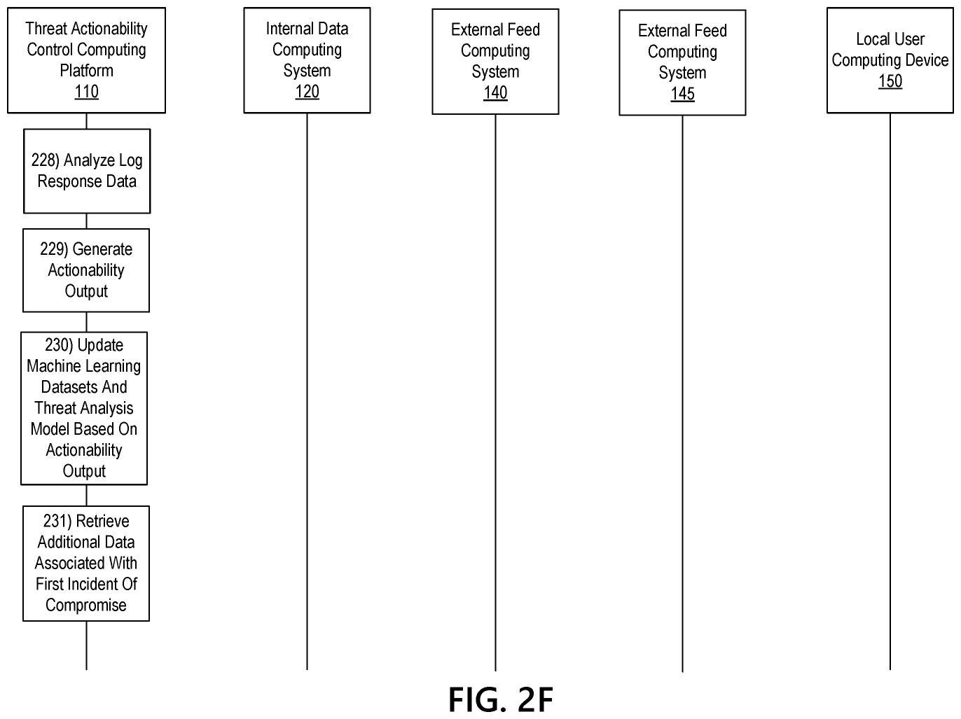

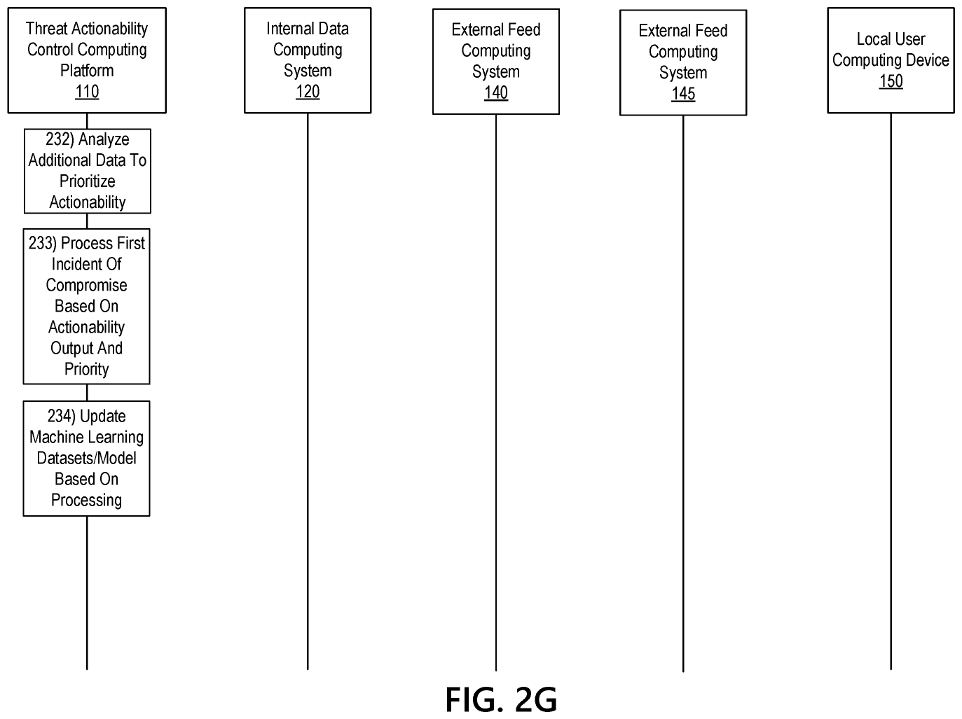

FIGS. 2A-2G depict one example illustrative event sequence for implementing and using threat actionability control functions in accordance with one or more aspects described herein. The events shown in the illustrative event sequence are merely one example sequence and additional events may be added, or events may be omitted, without departing from the invention.

Referring to FIG. 2A, at step 201, a request to initiate threat actionability control functions may be received by, for example, local user computing device 150. For instance, a user, such as an employee of an entity implementing the threat actionability control computing platform 110, may input, into a computing device, such as local user computing device 150, a request to initiate threat actionability control functions.

At step 202, a connection may be established between the local user computing device 150 and the threat actionability control computing platform 110. For instance, a first wireless connection may be established between the local user computing device 150 and the threat actionability control computing platform 110. Upon establishing the first wireless connection, a communication session may be initiated between the local user computing device 150 and the threat actionability control computing platform 110.

At step 203, the request to initiate threat actionability control functions may be transmitted from the local user computing device 150 to the threat actionability control computing platform 110. For instance, the request to initiate threat actionability control functions may be transmitted during the communication session established upon initiating the first wireless connection.

At step 204, the request to initiate threat actionability control functions may be received by the threat actionability control computing platform 110 and executed to initiate and/or activate one or more threat actionability control functions. For instance, one or more threat actionability control functions that was previously disabled or unavailable may be enabled, activated and/or initiated.

At step 205, a request for threat intelligence data may be generated. For instance, a request for threat intelligence data including raw intelligence data from one or more intelligence data feeds may be generated. In some examples, each intelligence data feed may be provided by different sources which may be internal or external to the entity implementing the threat actionability control computing platform 110.

With reference to FIG. 2B, at step 206, a connection may be established between the threat actionability control computing platform 110 and external feed computing system 140. For instance, a second wireless connection may be established between the threat actionability control computing platform 110 and external feed computing system 140. Upon establishing the second wireless connection, a communication session may be initiated between the threat actionability control computing platform 110 and the external feed computing system 140.

At step 207, a request for threat intelligence data may be transmitted from the threat actionability control computing platform 110 to the external feed computing system 140. In some examples, the request for threat intelligence data may be transmitted during the communication session initiated upon establishing the second wireless connection. The request may include request for transmission of intelligence feed data in a continuous stream in at least some examples.

At step 208, the request for threat intelligence data may be received by the external feed computing system 140 and may be executed by the external feed computing system 140. In some examples, executing the request may include executing an instruction or command identifying threat intelligence feed data for transmission.

At step 209, first threat intelligence response data may be generated by the external feed computing system 140. In some examples, the first threat intelligence response data may include a stream of threat intelligence data as captured or otherwise procured by the entity (e.g., external entity) associated with the external feed computing system 140.

At step 210, the first threat intelligence response data may be transmitted from the external feed computing system 140 to the threat actionability control computing platform 110. In some examples, the first threat intelligence response data may be transmitted via the communication session initiated upon establishing the second wireless connection.

At step 211, the first threat intelligence response data may be received by the threat actionability control computing platform 110.

With reference to FIG. 2C, at step 212, a connection may be established between the threat actionability control computing platform 110 and external feed computing system 145. For instance, a third wireless connection may be established between the threat actionability control computing platform 110 and external feed computing system 145. Upon establishing the third wireless connection, a communication session may be initiated between the threat actionability control computing platform 110 and the external feed computing system 145.

At step 213, a request for threat intelligence data may be transmitted from the threat actionability control computing platform 110 to the external feed computing system 145. In some examples, the request for threat intelligence data may be transmitted during the communication session initiated upon establishing the third wireless connection. The request may include request for transmission of intelligence feed data in a continuous stream in at least some examples.

At step 214, the request for threat intelligence data may be received by the external feed computing system 145 and may be executed by the external feed computing system 145. In some examples, executing the request may include executing an instruction or command identifying threat intelligence feed data for transmission.

At step 215, second threat intelligence response data may be generated by the external feed computing system 145. In some examples, the second threat intelligence response data may include a stream of threat intelligence data as captured or otherwise procured by the entity (e.g., external entity) associated with the external feed computing system 145.

At step 216, the second threat intelligence response data may be transmitted from the external feed computing system 145 to the threat actionability control computing platform 110. In some examples, the second threat intelligence response data may be transmitted via the communication session initiated upon establishing the third wireless connection.

At step 217, the second threat intelligence response data may be received by the threat actionability control computing platform 110.

With reference to FIG. 2D, at step 218, the first threat intelligence response data and second threat intelligence response data may be analyzed to identify any potential issues. Various systems and methods for analyzing the data may be used without departing from the invention. Also, in some example arrangements, step 218 may be omitted and the process may move directed to step 219 where the raw feed data may be analyzed.

At step 219, a first indicator of compromise may be identified for analysis. For instance, a first indicator of compromised may be identified from the analyzed data (e.g., at step 218) or from the raw intelligence feed data (e.g., if step 218 is omitted).

At step 220, an intelligence type associated with the first indicator of compromise may be identified or determined. For instance, the first indicator of compromise may be analyzed to identify an intelligence type associated with the first indicator of compromise, for example, based on text within the indicator, syntax of the indicator, or the like.

At step 221, one or more system logs for evaluation may be identified based on the identified intelligence type associated with the first indicator of compromise. For instance, in some examples, to determine whether an indicator of compromise is actionable, a determination may be made as to whether the indicator of compromise has been identified in one or more entity systems (e.g., is the indicator present within the entity. If not, the indicator may be a credible threat but not to the entity at that time because it is not present in the systems.). In order to efficiently, effectively and accurately determine whether the first indicator of compromise is present in an entity system, one or more system logs may be identified for evaluation based on the intelligence type associated with the first indicator of compromise. In some arrangements, various intelligence types may be mapped to one or more system logs. Accordingly, upon identifying an intelligence type of an indicator of compromise, one or more system logs mapped to that intelligence type may be identified and retrieved. For instance, if an intelligence type associated with the first indicator of compromise is an email address (e.g., based on syntax, presence of certain text, or the like), email logs may be identified for evaluation to determine whether the first indicator of compromise is present. Identifying and retrieving system logs mapped to the intelligence type may improve efficiency and accuracy of the system by narrowing the number of logs for review, honing the review process to logs in which an indicator of compromise is most likely to appear, and the like. Accordingly, computing resources are conserved by executing a focused search for a particular indicator of compromise.

With reference to FIG. 2E, at step 222, a request for the identified system logs may be generated. For instance, the identified system logs may be resident on one or more computing systems or devices of the entity (e.g., internal systems or devices). Accordingly, a request to retrieve the identified logs, including log identifying information, may be generated.

At step 223, a connection may be established between the threat actionability control computing platform 110 and internal data computing system 120. For instance, a fourth wireless connection may be established between the threat actionability control computing platform 110 and internal data computing system 120. Upon establishing the third fourth connection, a communication session may be initiated between the threat actionability control computing platform 110 and the internal data computing system 120.

At step 224, the request for identified system logs may be transmitted from the threat actionability control computing platform 110 to the internal data computing system 120. For instance, the request for identified logs may be transmitted during the communication session initiated upon establishing the fourth wireless connection.

At step 225, the request for identified system logs may be received and executed by the internal data computing system 120. Executing the request may include executing an instruction or command to retrieve the identified system logs.

At step 226, system log response data may be generated by the internal data computing system 120. For instance, system log response data including the requested system logs may be generated.

At step 227, the system log response data may be transmitted from the internal data computing system 120 to the threat actionability control computing platform 110. In some examples, the system log response data may be transmitted during the communication session initiated upon establishing the fourth wireless connection.

With reference to FIG. 2F, at step 228, the system log response data may be analyzed to identify any presence or occurrence of the first indicator of compromise. Based on the analysis of the system logs, a binary actionability output may be generated at step 229. For instance, if the analysis indicates a presence or occurrence of the first indicator of compromise, an output that the first indicator of compromise is actionable may be generated. If the analysis indicates that there is no presence or occurrence of the first indicator of compromise in the system logs, an output of inactionable may be generated.

At step 230, any models, machine learning datasets, and the like, used in the threat intelligence analysis arrangement may be updated based on the actionability output. For instance, models, machine learning datasets, and the like, may be updated or validated based on the actionability output. These updates may then be used to improve accuracy in predicting a likelihood of impact in threat intelligence analysis, in prioritizing actionable items, and the like.

At step 231, additional data associated with the first indicator of compromise may be retrieved. For instance, previous occurrences of the first indicator of compromise, as well as mitigating actions executed and an outcome may be retrieved. In other examples, a source of the intelligence feed data that included the first indicator of compromise may be identified.

With reference to FIG. 2G, at step 232, the additional data and actionability output may be analyzed to prioritize the first incident of compromise for further processing. For instance, a severity, urgency, or the like, may be determined based on analysis of the additional data and actionability output and a priority or ranking may be determined for the first indicator of compromise. In some examples, machine learning may be used to identify patterns or sequences in the additional data and actionability output in order to prioritize the first incident of compromise.

In some examples, a priority of the indicator of compromise may dictate next steps taken in further processing the indicator of compromise. For instance, all actionable items may not be handled in same way or with a same further processing procedure or technique. In some arrangements, based on additional information, priority, and the like, associated with the actionable indicator of compromise, next steps, urgency or order of evaluation, and/or a further processing procedure may be identified. In one example, if historical data indicates that the indicator of compromise, or similar indicators of compromise, have had an impact on the entity, the indicator of compromise may be given a higher priority or ranking to ensure that the indicator or compromise is quickly and efficiently processed and evaluated to mitigate any impact. In another example, if an indicator of compromise is determined to be actionable but the source from which the indicator of compromise is identified as not reliable, the indicator of compromise may be given a lower priority or ranking and may be further processed or evaluated on a less urgent time frame.

At step 233, the first incident of compromise may be further processed based on the actionability output and the determined priority or ranking. For instance, the first incident of compromise may be further processed to identify mitigating actions to avoid impact, execute one or more mitigating actions, evaluate impact of the first incident of compromise, and the like. In some examples, the first incident of compromise, actionability output and priority may be transmitted to, for instance, another computing device for further analysis, identification of mitigating actions, execution of mitigating actions and the like. In some arrangements, an analyst may review the first incident of compromise, actionability output, priority, and the like, to determine mitigating actions, evaluate impact of the first incident of compromise, and the like. In some examples, the analyst may provide outcomes or findings of the analysis via an interactive user interface that enables seamless integration of the findings (e.g., did an incident occur, were mitigating actions effective, was there no issue at all, or the like) into one or more systems or models to update and/or validate the models and dataset for future use. In some examples, the analyst may provide an indication of whether the data provided was accurate.

After further processing is completed, at step 234, one or more machine learning datasets and/or models may be updated and/or validated based on the outcome of the further processing. For instance, mitigating actions taken, a final outcome or impact, and the like, may be used to update and/or validate one or more machine learning datasets and/or models to further improve the accuracy in identifying potential threats, determining actionability, determining priority of actionable items, and the like.

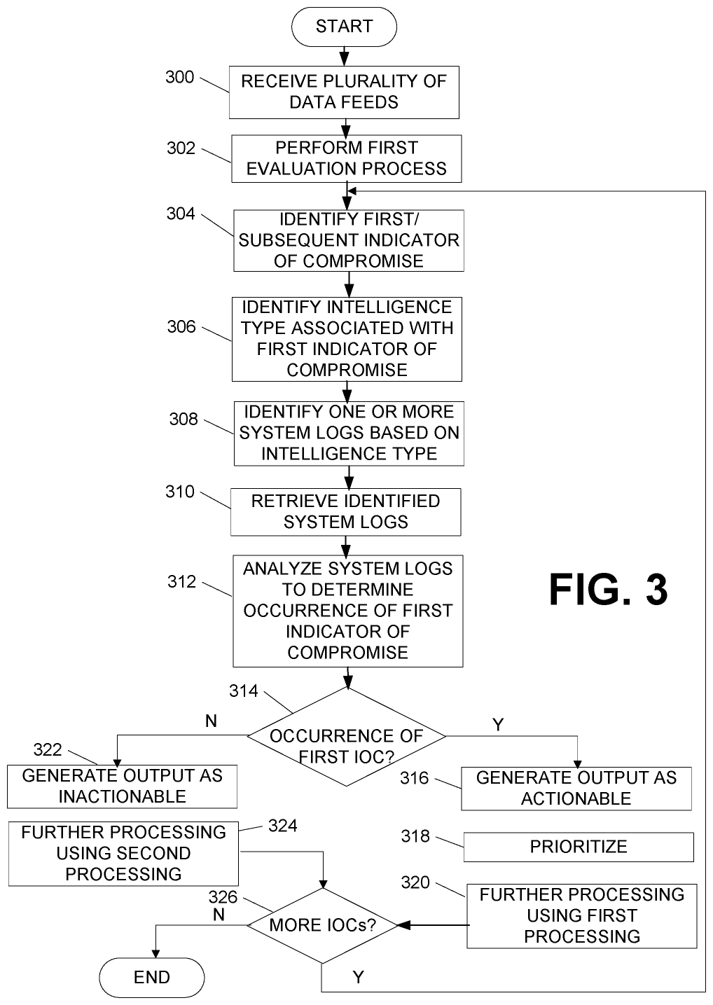

FIG. 3 is a flow chart illustrating one example method of threat actionability control according to one or more aspects described herein. The processes illustrated in FIG. 3 are merely some example processes and functions. The steps shown may be performed in the order shown, in a different order, more steps may be added, or one or more steps may be omitted, without departing from the invention.

At step 300, a plurality of threat intelligence data feeds may be received. The plurality of threat intelligence data feeds may be received from a plurality of sources (e.g., intelligence threat data feeds from a plurality of providers). In some examples, the data feeds may include various indicators of compromise or potential compromise. In some examples, the indications may include words or terms, universal resource locators (URL), hash tags, email addresses, and the like.

At step 302, a first threat intelligence evaluation process may be performed on the threat intelligence data feeds. For instance, various threat intelligence analysis may be performed to identify potential threats, evaluate credibility of threats, predict likely impact of threats, and the like. In some examples, step 302 may be omitted and the remaining steps may be performed on the raw data from the plurality of threat intelligence data feeds.

At step 304, a first indicator of compromise may be identified. For instance, the threat intelligence data (e.g., analyzed data or raw data), such as a first threat intelligence data feed, may be analyzed to identify a first indicator of compromise for evaluation. In some examples, the first indicator of compromise may be a threat or potential threat as identified in step 302.

At step 306, an intelligence type associated with the first indicator of compromise may be identified. For instance, a type of intelligence may be determined based on syntax of the indicator of compromise (e.g., @xxx.com may indicate an email address), text within the indicator of compromise (e.g., .com may indicate an email address, www may indicate a URL, or the like), and the like.

At step 308, one or more system logs for evaluation may be identified based on the determined or identified intelligence type associated with the first indicator of compromise. For instance, one or more system logs including the identified intelligence type may be identified and retrieved from, for example, one or more systems, devices, or the like, associated with the entity implementing the threat actionability control computing platform.

At step 310, the identified system logs may be retrieved (e.g., an instruction or command to transmit the logs may be transmitted to one or more computing systems, devices, or the like, and system log response data may be transmitted).

At step 312, the retrieved system logs may be analyzed to determine whether a presence or occurrence of the first indicator of compromise exists in the identified system logs. At step 314, a determination is made, based on the analysis in step 312 of whether a presence or occurrence of the first indicator of compromise is in the system logs. A binary output may be generated based on the determination. For instance, if, at step 314, the first indicator of compromise does appear in the system logs, at step 316, an output of actionable may be generated. An actionable output may indicate that the first indicator of compromise is verified, is clear and present within the computing environment of the entity.

At step 318, additional information associated with the actionable first indicator of compromise may be received and evaluated to prioritize further processing of the first indicator of compromise. For instance, a source of the first indicator of compromise, data associated with previous occurrences of the first indicator of compromise, and the like, may be received and analyzed (e.g., using machine learning) to prioritize or rank the first indicator of compromise for further processing.

At step 320, the first indicator of compromise may be further processed according to a first processing procedure. For instance, because the first indicator of compromise is actionable at step 320, the first indicator of compromise, additional information, priority, and the like, may be further processed to identify mitigating actions to implement, execute one or more mitigating actions, capture an outcome of the mitigating actions, and the like.

If, at step 314, the first indicator of compromise does not exist in the system logs, the first indicator of compromise may be identified as inactionable at step 322. Accordingly, because the first indicator of compromise is determined to be inactionable, at step 324 the first indicator of compromise may be further processed according to a second processing procedure different from the first processing procedure. For instance, the first indicator of compromise may be added to a log for later evaluation, may be deleted from the system, or the like.

At step 326, a determination may be made as to whether there are additional indicators of compromise for evaluation (e.g., a second or subsequent indicator of compromise). If so, the process may return to step 304 to identify additional indicators of compromise for evaluation. If not, the process may end.

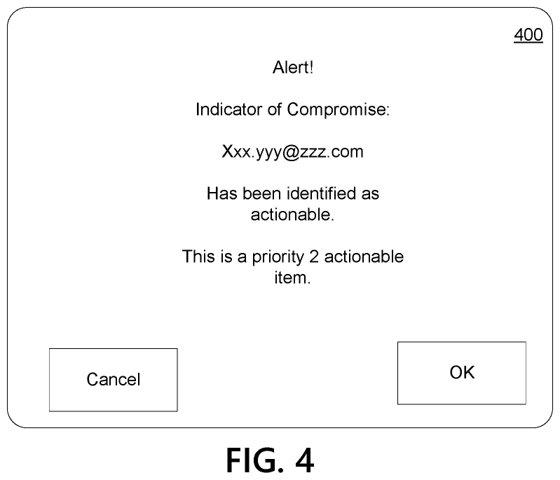

FIG. 4 illustrates one example user interface that may be generated according to one or more aspects described herein. The interface 400 may include identification of the indicator compromise identified as actionable, as well as priority for further processing the indicator of compromise. In some examples, a user interface such as interface 400 may be transmitted to an analyze and further evaluation/processing of the actionable indicator of compromise may occur.

As discussed herein, aspects described provide for dynamic actionability determination and control of threat intelligence data, including one or more indicators of compromise. As discussed herein, the arrangements described may be performed on raw intelligence feed data received from one or more sources (e.g., external data feed sources) or may be performed on threat intelligence data that has been previously analyzed. For instance, threat intelligence data feeds may be received by the system and evaluated (e.g., metadata from the feeds may be analyzed using one or more models, or the like) to determine accuracy associated with the intelligence, with a source of the intelligence, or the like. This data may be used to update models and/or machine learning datasets to improve accuracy in evaluating future intelligence data.

In some examples, data from a source may be deemed reliable because the source is a closed source (e.g., does not repeat data from other sources). However, as intelligence data is analyzed, indicators of compromise are identified and evaluated, the reliability of the source and accuracy of data may be determined. This accuracy determination may be fed back into the models performing an initial evaluation of the threat intelligence feed data to improve accuracy.

However, merely understanding whether data indicating a threat or potential threat is reliable may not be sufficient to efficiently protect entity systems. Rather, determining whether the threat or potential threat (e.g., indicator of compromise) is actionable is important. In some examples, actionability may indicate that the indicator of compromise is present in an entity system. Accordingly, if a threat is verified and is clear and present in the entity system, the indicator of compromise may be actionable and should be efficiently evaluated.

In order to determine whether the threat is actionable, system logs may be reviewed to determine whether the indicator of compromise exists in an entity system or environment. As discussed herein, an intelligence type associated with the indicator of compromise may be identified and system logs mapped to that intelligence type may be retrieved for analysis. This may greatly reduce the computing resources needed to evaluate each indicator of compromise by evaluating system logs that are likely to include data of that intelligence type. For instance, if the indicator of compromise is an IP address, logs including IP addresses may be analyzed. In some examples, only logs including or mapped to the identified intelligence type may be retrieved and evaluated. This avoids unnecessary load on the system performing the evaluation.

In some examples, the arrangements discussed herein may be performed on a real-time or near real-time basis as data is received. Additionally or alternatively, the data may be analyzed on a periodic or aperiodic basis.

In some arrangements, data associated with actionable indicators of compromise may be shared with entities other than the entity implementing the threat actionability control computing platform. For instance, data associated with the indicator of compromise may be sanitized to remove a personal identifying information, entity identifying information, confidential or private information, other non-attributable information, and the like, and may be distributed to other entities to aid in identifying potential threats to those entities. This process may enable safe sharing of data to mitigate impact of threats.

The arrangements described herein may enable entities who may receive, for example, hundreds of thousands of potential threats per day, to identify actionable threats and further process or evaluate the actionable threats in a timely manner to mitigate impact of the threat. For example, some entities may receive several hundred thousand indicators of compromise for evaluation each day. By executing the processes described herein to identify actionable indicators of compromise, further processing or analysis may be performed on, in some example, fewer than 10 items.

Further, one or more reports indicating accuracy, reliability, and the like, of one or more sources may be generated. In some examples, graphical representations may be used to illustrate sources of intelligence that repeat data, sources of repeated data, only provide non-repeated data, and the like. In some examples, sources providing a same or same type of information may be identified to streamline sources from which data is received.

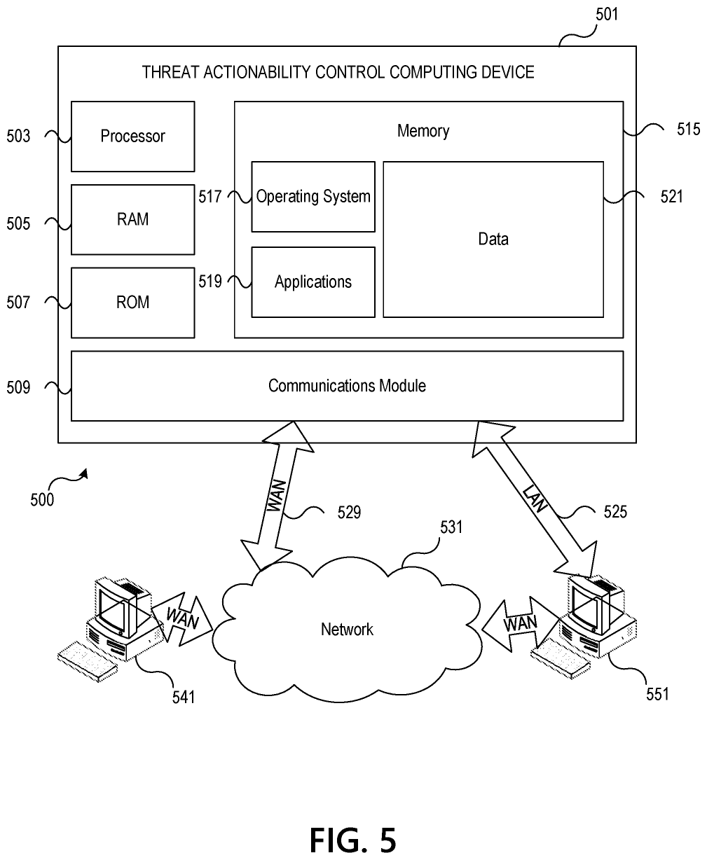

FIG. 5 depicts an illustrative operating environment in which various aspects of the present disclosure may be implemented in accordance with one or more example embodiments. Referring to FIG. 5, computing system environment 500 may be used according to one or more illustrative embodiments. Computing system environment 500 is only one example of a suitable computing environment and is not intended to suggest any limitation as to the scope of use or functionality contained in the disclosure. Computing system environment 500 should not be interpreted as having any dependency or requirement relating to any one or combination of components shown in illustrative computing system environment 500.

Computing system environment 500 may include threat actionability control computing device 501 having processor 503 for controlling overall operation of threat actionability control computing device 501 and its associated components, including Random Access Memory (RAM) 505, Read-Only Memory (ROM) 507, communications module 509, and memory 515. Threat actionability control computing device 501 may include a variety of computer readable media. Computer readable media may be any available media that may be accessed by threat actionability control computing device 501, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on threat actionability control computing device 501. Such a processor may execute computer-executable instructions stored on a computer-readable medium.

Software may be stored within memory 515 and/or storage to provide instructions to processor 503 for enabling threat actionability control computing device 501 to perform various functions as discussed herein. For example, memory 515 may store software used by threat actionability control computing device 501, such as operating system 517, application programs 519, and associated database 521. Also, some or all of the computer executable instructions for threat actionability control computing device 501 may be embodied in hardware or firmware. Although not shown, RAM 505 may include one or more applications representing the application data stored in RAM 505 while threat actionability control computing device 501 is on and corresponding software applications (e.g., software tasks) are running on threat actionability control computing device 501.

Communications module 509 may include a microphone, keypad, touch screen, and/or stylus through which a user of threat actionability control computing device 501 may provide input, and may also include one or more of a speaker for providing audio output and a video display device for providing textual, audiovisual and/or graphical output. Computing system environment 500 may also include optical scanners (not shown).

Threat actionability control computing device 501 may operate in a networked environment supporting connections to one or more remote computing devices, such as computing devices 541 and 551. Computing devices 541 and 551 may be personal computing devices or servers that include any or all of the elements described above relative to threat actionability control computing device 501.

The network connections depicted in FIG. 5 may include Local Area Network (LAN) 525 and Wide Area Network (WAN) 529, as well as other networks. When used in a LAN networking environment, threat actionability control computing device 501 may be connected to LAN 525 through a network interface or adapter in communications module 509. When used in a WAN networking environment, threat actionability control computing device 501 may include a modem in communications module 509 or other means for establishing communications over WAN 529, such as network 531 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

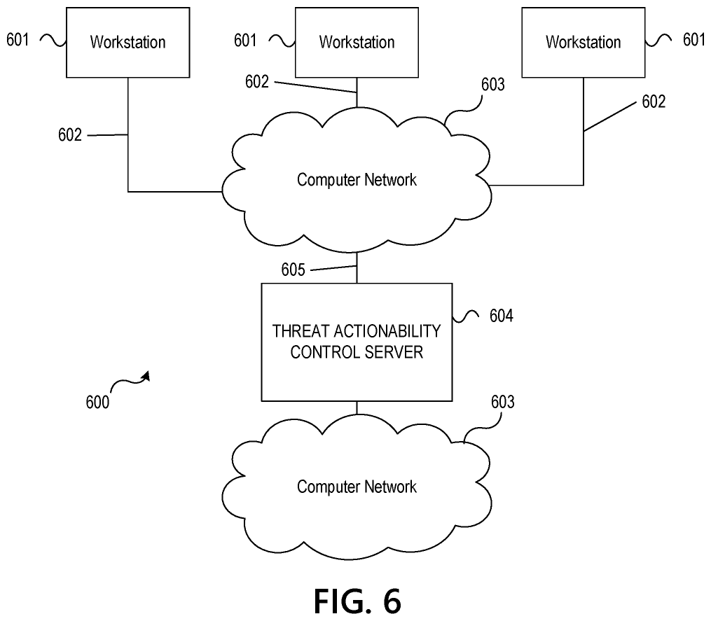

FIG. 6 depicts an illustrative block diagram of workstations and servers that may be used to implement the processes and functions of certain aspects of the present disclosure in accordance with one or more example embodiments. Referring to FIG. 6, illustrative system 600 may be used for implementing example embodiments according to the present disclosure. As illustrated, system 600 may include one or more workstation computers 601. Workstation 601 may be, for example, a desktop computer, a smartphone, a wireless device, a tablet computer, a laptop computer, and the like, configured to perform various processes described herein. Workstations 601 may be local or remote, and may be connected by one of communications links 602 to computer network 603 that is linked via communications link 605 to threat actionability control server 604. In system 600, threat actionability control server 604 may be a server, processor, computer, or data processing device, or combination of the same, configured to perform the functions and/or processes described herein. Server 604 may be used to receive a plurality of threat intelligence data feeds, perform one or more evaluation processes on the plurality of threat intelligence data feeds, identify an incident of compromise, identify an intelligence type associated with the incident of compromise, identify and retrieve system logs, evaluate system logs to identify an occurrence of the incident of compromise, prioritize the incident of compromise, and the like.

Computer network 603 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. Communications links 602 and 605 may be communications links suitable for communicating between workstations 601 and threat actionability control server 604, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to:
receive a plurality of threat intelligence data feeds from a plurality of sources, each threat intelligence data feed of the plurality of threat intelligence data feeds including intelligence data including a plurality of indicators of compromise and each intelligence feed being received from a respective source;
identify, within a first threat intelligence data feed, a first indicator of compromise;
analyze the identified first indicator of compromise to determine an intelligence type associated with the first indicator of compromise;
based on the identified intelligence type associated with the first indicator of compromise, retrieve one or more system logs associated with the identified intelligence type;
compare the first indicator of compromise to the retrieved one or more system logs to determine whether an occurrence of the first indicator of compromise in the one or more system logs exists;
based on the comparing, generate a binary output, generating the binary output including:
responsive to determining that an occurrence of the first indicator of compromise exists in the one or more system logs, generate the binary output as actionable for the first indicator of compromise; and
responsive to determining that an occurrence of the first indicator of compromise does not exist in the one or more system logs, generate the binary output as inactionable for the first indicator of compromise.

2. The computing platform of claim 1, further including instructions that, when executed, cause the computing platform to:
responsive to generating the binary output as actionable for the first indicator of compromise, retrieve additional information associated with the first indicator of compromise; and
prioritize further processing of the first indicator of compromise based on the binary output and the additional information.

3. The computing platform of claim 2, wherein the additional information includes at least the respective source from which the first threat intelligence data feed was received.

4. The computing platform of claim 2, wherein the additional information includes at least historical data associated with a previous occurrence of the first indicator of compromise.

5. The computing platform of claim 2, wherein prioritizing further processing of the first indicator of compromise is performed using machine learning.

6. The computing platform of claim 2, further including instructions that, when executed, cause the computing platform to:
transmit the first indicator of compromise and priority for further processing.

7. The computing platform of claim 6, wherein the further processing includes at least identifying one or more mitigating actions to execute.

8. A method, comprising:
by a computing platform comprising at least one processor, memory, and a communication interface:
receiving, by the at least one processor, a plurality of threat intelligence data feeds from a plurality of sources, each threat intelligence data feed of the plurality of threat intelligence data feeds including intelligence data including a plurality of indicators of compromise and each intelligence feed being received from a respective source;
identifying, by the at least one processor and within a first threat intelligence data feed, a first indicator of compromise;
analyzing, by the at least one processor, the identified first indicator of compromise to determine an intelligence type associated with the first indicator of compromise;
based on the identified intelligence type associated with the first indicator of compromise, retrieving, by the at least one processor, one or more system logs associated with the identified intelligence type;
comparing, by the at least one processor, the first indicator of compromise to the retrieved one or more system logs to determine whether an occurrence of the first indicator of compromise in the one or more system logs exists;
based on the comparing, generating, by the at least one processor, a binary output, generating the binary output including:
when it is determined that an occurrence of the first indicator of compromise exists in the one or more system logs, generate the binary output as actionable for the first indicator of compromise; and
when it is determined that an occurrence of the first indicator of compromise does not exist in the one or more system logs, generate the binary output as inactionable for the first indicator of compromise.

9. The method of claim 8, further including:
responsive to generating the binary output as actionable for the first indicator of compromise, retrieving, by the at least one processor, additional information associated with the first indicator of compromise; and
prioritizing, by the at least one processor, further processing of the first indicator of compromise based on the binary output and the additional information.

10. The method of claim 9, wherein the additional information includes at least the respective source from which the first threat intelligence data feed was received.

11. The method of claim 9, wherein the additional information includes at least historical data associated with a previous occurrence of the first indicator of compromise.

12. The method of claim 9, wherein prioritizing further processing of the first indicator of compromise is performed using machine learning.

13. The method of claim 9, further including instructions that, when executed, cause the computing platform to:
transmit the first indicator of compromise and priority for further processing.

14. The method of claim 13, wherein the further processing includes at least identifying one or more mitigating actions to execute.

15. One or more non-transitory computer-readable media storing instructions that, when executed by a computing platform comprising at least one processor, memory, and a communication interface, cause the computing platform to:
receive a plurality of threat intelligence data feeds from a plurality of sources, each threat intelligence data feed of the plurality of threat intelligence data feeds including intelligence data including a plurality of indicators of compromise and each intelligence feed being received from a respective source;
identify, within a first threat intelligence data feed, a first indicator of compromise;
analyze the identified first indicator of compromise to determine an intelligence type associated with the first indicator of compromise;
based on the identified intelligence type associated with the first indicator of compromise, retrieve one or more system logs associated with the identified intelligence type;
compare the first indicator of compromise to the retrieved one or more system logs to determine whether an occurrence of the first indicator of compromise in the one or more system logs exists;
based on the comparing, generate a binary output, generating the binary output including:
responsive to determining that an occurrence of the first indicator of compromise exists in the one or more system logs, generate the binary output as actionable for the first indicator of compromise; and
responsive to determining that an occurrence of the first indicator of compromise does not exist in the one or more system logs, generate the binary output as inactionable for the first indicator of compromise.

16. The one or more non-transitory computer-readable media of claim 15, further including instructions that, when executed, cause the computing platform to:
responsive to generating the binary output as actionable for the first indicator of compromise, retrieve additional information associated with the first indicator of compromise; and
prioritize further processing of the first indicator of compromise based on the binary output and the additional information.

17. The one or more non-transitory computer-readable media of claim 16, wherein the additional information includes at least the respective source from which the first threat intelligence data feed was received.

18. The one or more non-transitory computer-readable media of claim 16, wherein the additional information includes at least historical data associated with a previous occurrence of the first indicator of compromise.

19. The one or more non-transitory computer-readable media of claim 16, wherein prioritizing further processing of the first indicator of compromise is performed using machine learning.

20. The one or more non-transitory computer-readable media of claim 16, further including instructions that, when executed, cause the computing platform to:
transmit the first indicator of compromise and priority for further processing.

21. The one or more non-transitory computer-readable media of claim 20, wherein the further processing includes at least identifying one or more mitigating actions to execute.
